(19) United States
(12) Patent Application Publication
(10) Pub. No.: US 2021/0264020 A1
(43) Pub. Date: Aug. 26, 2021

(54) TECHNOLOGY TO CONTROL SYSTEM CALL INVOCATIONS WITHIN A SINGLE ADDRESS SPACE

(71) Applicant: Intel Corporation, Santa Clara, CA (US)

(72) Inventors: Michael LeMay, Hillsboro, OR (US); Anjo Vahldiek-Oberwagner, Portland, OR (US)

(73) Assignee: Intel Corporation, Santa Clara, CA (US)

(21) Appl. No.: 17/314,349

(22) Filed: May 7, 2021

Related U.S. Application Data
(60) Provisional application No. 63/021,935, filed on May 8, 2020.

(51) Int. Cl. G06F 21/53

(52) U.S. Cl. CPC G06F 21/53; G06F 2221/033

(57) ABSTRACT

Systems, apparatuses and methods may provide for technology that stores a security monitor at a first location in an address space, wherein the security monitor is to control requests to use a security-critical instruction at a second location in the address space, and wherein the second location is in the first set of locations. The technology also installs a control instruction at an entry point to the security monitor, wherein the control instruction is to restrict indirect branch targets, and excludes the control instruction from all locations in the first set of locations that are not entry points.

### CROSS-REFERENCE TO RELATED APPLICATIONS

The present application claims the benefit of priority to U.S. Provisional Patent Application No. 63/021,935, filed on May 8, 2020.

### TECHNICAL FIELD

Embodiments generally relate to control-flow enforcement. More particularly, embodiments relate to technology to control system call invocations within a single address space.

### BACKGROUND

Sandboxing is increasingly popular for containing compromise within untrusted software and for isolating mutually-distrustful tenants in web browsers and cloud hosting environments. For example, FIREFOX has recently adopted sandboxing for untrusted libraries, sandboxed cloud hosting for Function-as-a-Service (Faas) and content delivery networks has been deployed, and web browsers support sandboxed active content. Many of these sandboxes rely on the WEBASSEMBLY Virtual Machine (VM), but WEBASSEMBLY may have disadvantages compared to native code such as performance overhead, legacy compatibility limitations, and an inability to use advantageous hardware features.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of the arrangement and relevant interactions of a set of code pages according to an embodiment;

FIG. 2 is a flowchart of an example of a method of conducting an authorized indirect branch according to an embodiment;

FIG. 3 is a flowchart of an example of a method of blocking an unauthorized indirect branch according to an embodiment;

FIG. 4 is a flowchart of an example of a method of controlling direct jumps according to an embodiment;

FIGS. 5 and 6 are comparative block diagrams of examples of a LibOS (library operating system) system configuration based on GRAPHEME;

FIGS. 7A and 7B are flowcharts of examples of methods of operating a performance-enhanced computing system according to an embodiment;

FIG. 8 is a block diagram of an example of a computing system according to an embodiment;

FIG. 9 is an illustration of an example of a semiconductor apparatus according to an embodiment;

FIG. 10 is a block diagram of an example of a processor according to an embodiment; and

FIG. 11 is a block diagram of an example of a multi-processor based computing system according to an embodiment.

### DESCRIPTION OF EMBODIMENTS

Previous solutions may use 1) language-based VMs, 2) process-based isolation, 3) software-enforced control-flow integrity (CFI) and/or 4) kernel-based system call policy enforcement.

Language-based VMs in general have the disadvantages described for WEBASSEMBLY VMs specifically above.

Process-based isolation (and perhaps all of the previous solutions) requires changes to the software architecture and build system to divide and duplicate code and data between multiple processes and to perform inter-process communication and the associated serialization and deserialization. Such an approach introduces both complexity and performance overhead.

Software-enforced CFI does not provide an option for selectively enforcing CFI for just pages of memory containing security-critical code such as the system call instruction and its associated security checks. Requiring all code to be instrumented using software-enforced CFI would impose similar burdens and drawbacks as those described below for requiring ENDBRANCH instructions to be used throughout the program. In fact, the burdens would be greater, since it is more complicated to scan code for valid software CFI instrumentation compared to simply scanning for ENDBRANCH instructions.

Kernel-based system call policy enforcement requires that the kernel be aware of the sandboxes defined in userspace. This solution may shift complexity into the kernel, thus increasing the attack surface and lowering the overall security level for the system. Furthermore, kernel-based controls are inapplicable for hardening user mode LibOSes (library operating systems) such as GRAPHENE.

Embodiments described herein use technology such as the legacy code page bitmap defined in INTEL Control-flow Enforcement Technology (CET) or the Guarded Page (GP) field defined in ARM Branch Target Identification (BTI) to address one of the main gaps hindering native code sandboxing. Specifically, untrusted native code may invoke system calls from any code location, and some system calls can undermine sandboxing (e.g., by changing memory permissions). Existing OS kernel controls can enforce a single authorized system call location that can check the arguments of the call, but untrusted code may jump past the checks to directly invoke the system call instruction with unauthorized arguments.

Embodiments may use a control instruction such as the CET ENDBRANCH (e.g., ENDBR64) instruction or ARM branch target identification (BTI) instruction just on the pages of memory containing the authorized system call instruction. This approach avoids imposing the overheads of CET on all code pages within the program and has a variety of benefits:

Legacy compatibility for code that does not contain ENDBRANCH instructions.

Avoiding the unneeded overhead of requiring programs to include ENDBRANCH instructions even if the programs already enforce control-flow integrity (CFI) in other ways (e.g., using strictly-typed programming languages).

Embodiments may also use the CET shadow stack, ARM Pointer Authentication, or other software or hardware mechanisms such as LLVM SafeStack to enforce reverse-edge CFI.

Embodiments may also use a memory layout that prevents unauthorized direct branches from bypassing security checks. In an embodiment, malicious code is prevented from jumping past a user mode security monitor to directly invoke a system call instruction by only placing an ENDBRANCH instruction prior to the security monitor. If malicious code attempts to jump straight to the system call instruction, a #CP(ENDBRANCH) exception may be generated. The legacy code page bitmap is configured such that other code in the process that is not instrumented with ENDBRANCH instructions is still permitted to execute normally.

As a result, efficient support is provided for sandboxing, which is increasingly popular with independent software vendors (ISVs). In particular, embodiments efficiently support sandboxed native code so that ISVs are not left with language-based VMs. Embodiments amplify the value of technology such as CET by using the technology to block attempts to bypass sandbox security monitors in native code. Such an approach may also harden SW architectures for other security features such as GRAPHENE-SGX (Software Guard Extensions).

The program to be controlled may include a set of untrusted code pages for sandboxes as well as one or more code pages containing security-critical instructions. In one example, the execution of each security-critical instruction is preceded by the execution of a security monitor to control requests to use the instruction. In an embodiment, the untrusted code pages are only permitted to jump to an authorized entry point of the security monitor, not directly to the security-critical instruction.

These security requirements are balanced with legacy compatibility requirements to support a wide range of native code in the untrusted code pages.

Embodiments enforce the desired security policy by configuring and using CET in a particular manner:

Shadow stack is enabled throughout the program to enforce reverse-edge CFI.

An ENDBRANCH instruction is placed at each of one or more authorized entry points to the security monitor and nowhere else within the security monitor.

The CET legacy code page bitmap is configured so that the page(s) of memory containing the security monitor and security-critical instruction are not marked as legacy code pages.

The untrusted code pages may be marked as legacy code pages in the CET legacy code page bitmap if appropriate. For example, the untrusted code pages may contain legacy libraries that have not been instrumented with ENDBRANCH instructions. However, if some or all of the untrusted code pages have been instrumented with ENDBRANCH instructions, then those pages may be marked as non-legacy code pages. If all of the code pages have been instrumented with ENDBRANCH instructions, then the legacy code page bitmap feature may be disabled.

Alternative embodiments that use ARM BTI may analogously configure the Guarded Page (GP) field for various code pages.

In one example, a suppress disable control (e.g., the CET SUPPRESS DIS control) is set so that ENDBRANCH tracking is not suppressed when jumping to a legacy code page. Accordingly, when control returns to a non-legacy code page, such as a page containing a security-critical instruction, CET will check for an ENDBRANCH instruction.

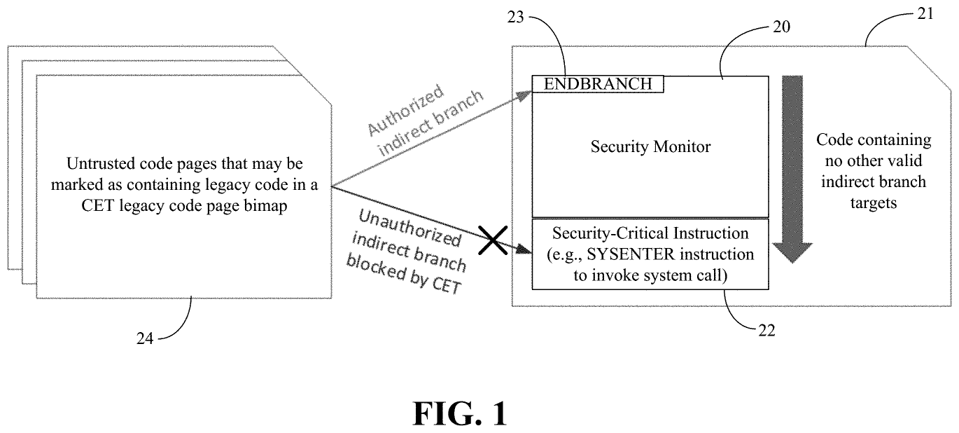

FIG. 1 illustrates the arrangement and relevant interactions of a set of code pages including a page 21 that is not marked in a CET legacy code bitmap as containing legacy code. In the illustrated example, an ENDBRANCH instruction 23 is used. In an embodiment, a security monitor 20 (e.g., including logic instructions) performs arbitrary security checks. Accordingly, embodiments ensure that the security monitor 20 maintains control over execution of a security-critical instruction 22, regardless of what policy is enforced by the security monitor 20. For example, the security monitor 20 may check parameters to system calls that update memory permissions and reject system calls targeting memory regions that are not owned by the currently-active sandbox.

Likewise, the kernel, informed by the startup routines in the program, may impose policies to restrict which code locations are authorized to contain security-critical instructions. Embodiments ensure that the security monitor 20 is able to restrict invocations of whatever security-critical instructions have been authorized by the kernel. For example, the kernel may be configured to allow a SYSENTER instruction to be used that is located at a fixed linear address. That permission can be enforced using a SECCOMP filter in the LINUX kernel, a system call user dispatch feature, or some other method of restricting system calls. Even if an untrusted code page 24 contains a SYSENTER instruction, the instruction will be at a different, unauthorized location, so any attempts to use the instruction will be rejected by the kernel.

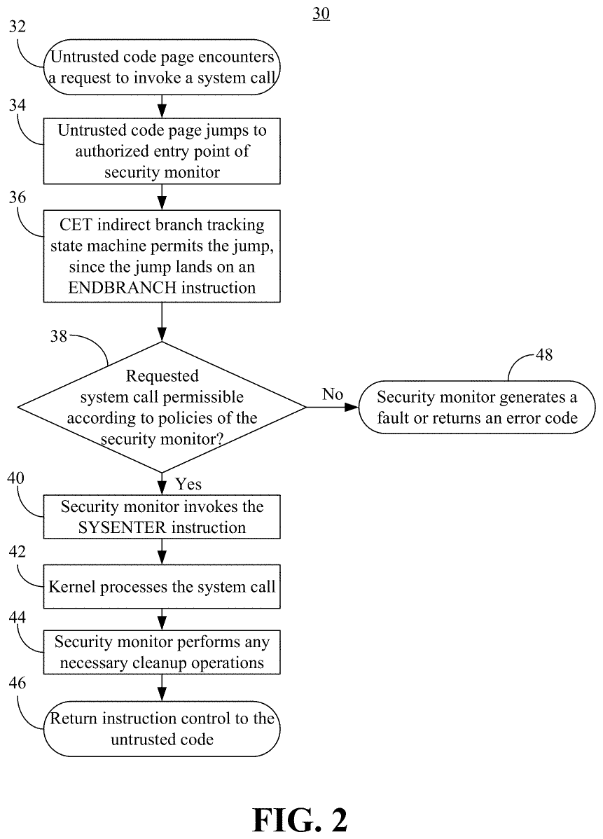

FIG. 2 illustrates a method 30 of performing a system call. The method 30 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

In illustrated processing block 32, an untrusted code page encounters a request to invoke a system call (e.g., SYSENTER instruction). In an embodiment, the untrusted code page jumps to an authorized entry point (e.g., marked using an ENDBRANCH instruction) of a security monitor at block 34. A CET indirect branch tracking state machine may permit the jump/branch at block 36 because the jump lands on an authorized entry point. In one example, a determination is made at block 38 as to whether the requested system call is permissible according to the policies of the security monitor. If so, the security monitor invokes the system call at block 40 and the kernel processes the system call at block 42. In an embodiment, the security monitor performs any necessary cleanup operations at block 44 and instruction control is returned to the untrusted code at block 46. If it is determined at block 38 that the requested system call is not permissible, the security monitor generates a fault or returns an error code at block 48. In this example, “authorized” means that it is authorized by an embodiment as a location to begin invoking the security monitor code (e.g., such that all required security checks will be performed). This authorization does not imply that the security monitor will grant the request to invoke the system call after inspecting the arguments of the system call.

Some embodiments may record in a register, set of registers, or in-memory log whether the previous indirect branch landed on a landing pad instruction such as an ENDBRANCH instruction (e.g., authorized entry point). That recording may be enabled for specific modes (e.g., user mode rather than supervisor mode), to prevent the recording from being overwritten by code outside of the designated mode. Alternatively, a longer history may be recorded than for just the most recent indirect branch. The kernel in block 42 may check whether the most recent user mode indirect branch landed on an ENDBRANCH instruction and block access to the system call routine if it did not. The recording of whether branches land on landing pad instructions may be configured to be performed only for branches originating outside of the security monitor. This recording may be extended to direct branches. Different branch types may be controlled similarly, or separate controls may be supported to configure which types of branches to track. Some embodiments may define a new type of system call instruction or enhance an existing system call instruction to generate an exception if the record of whether branches land on landing pad instructions indicates in its most recent entry that the relevant branch did not land on a landing pad instruction.

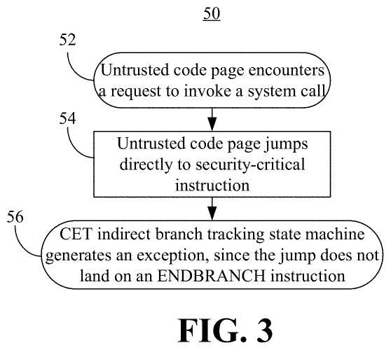

FIG. 3 illustrates a method 50 of conducting an unauthorized flow. The method 50 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

In illustrated processing block 52, an untrusted code page encounters a request to invoke a system call (e.g., SYSENTER instruction) and the untrusted code page jumps directly to a security-critical instruction at block 54. The terms “jump” and “branch” are typically used interchangeably herein, although this description sometimes refers specifically to jumps as a specific category of branches distinct from function call and return instructions. In an embodiment, a CET indirect branch tracking state machine generates an exception at block 56 because the jump does not land on an authorized entry point (e.g., ENDBRANCH instruction) to a security monitor.

Of particular note is that security monitors containing sensitive data may include data memory access controls in addition to the branch controls in embodiments. Other work has described various ways to control data memory accesses (e.g., using the INTEL Memory Protection Key (MPK) feature), and those approaches may complement the technology described herein. Not all security monitors contain sensitive data, however, so the embodiments alone are adequate for those cases.

A secondary benefit of restricting entry points into the security monitor is that such a restriction reduces the number of “gadgets” available for return- or jump-oriented exploit programs. This concern may have been addressed by the CET feature, and it can still be achieved to some extent even if only the security monitor uses ENDBRANCH instructions.

Besides indirect jumps, calls, or returns, unauthorized direct jumps could circumvent the previously described technique to control system call invocations. Direct jump targets in the untrusted application may point to some location in the security monitor that is not an authorized entry point such as directly to the SYSENTER instruction. Unauthorized entry points may bypass security checks or perform other unauthorized behavior Direct jump targets pointing to an ENDBRANCH instruction or just past it to the next instruction are authorized, since they do not bypass security checks. Direct jumps to unauthorized entry points may exist inadvertently within the binary code of the untrusted application and are exploitable, since control flow within the untrusted application is not restricted allowing jumps to any byte-aligned address. The exploitation of direct jumps is prevented by carefully placing the security monitor in a memory area which is not a target of any unauthorized direct jump.

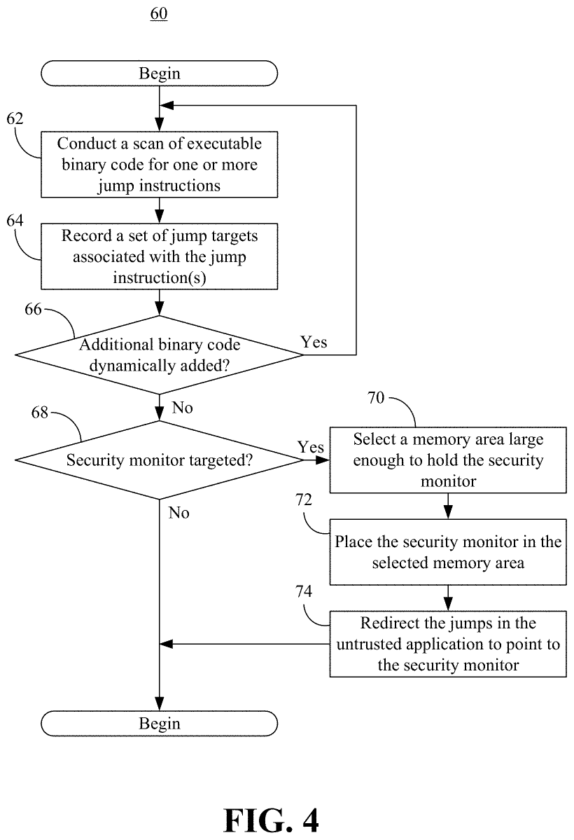

For example, FIG. 4 shows a method 60 of controlling direct jumps. The method 60 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Before the start of the untrusted application, the security monitor may perform the method 60 to ensure that any unauthorized entry points to the security monitor are out of reach of the untrusted application. Illustrated processing block 62 scans executable binary code in an untrusted application for one or more jump instructions. Block 64 may record a set of jump targets associated with the jump instruction(s). In an embodiment, a determination is made at block 66 as to whether additional binary code is dynamically added. If so, the illustrated method 60 returns to block 62. Otherwise, block 68 may determine whether any of the direct jumps target an unauthorized portion of the security monitor. If so, block 70 selects a memory area large enough to hold the security monitor and block 72 places the security monitor in the selected memory area. Additionally, block 74 may redirect authorized jumps in the untrusted application to point to the new location of the security monitor. If the new location is unreachable from previous authorized direct branches, then block 74 may insert trampoline code that is reachable from the previous authorized direct branches and that is able to reach the new location of the security monitor. For example, the trampoline code may use a direct branch if the security monitor is reachable using a direct branch located in the trampoline code, or the trampoline code may use an indirect branch if the security monitor is too distant from the trampoline code to be reached using a direct branch. In one example, the method 60 terminates after block 74. If it is determined at block 68 that none of the direct jumps target any unauthorized entry points in the security monitor, the method 60 may bypass blocks 70, 72, and 74, and terminate.

Using the observation that on some architectures direct jumps may displace the instruction pointer by an amount that may be much smaller than the maximum size of the linear address space, the method 60 may be optimized by carefully placing the untrusted application and security monitor. As long as the application loader ensures sufficient distance between the untrusted application code area and the security monitor code area (e.g., more than 2GiB apart for x86, which expresses direct jump offsets as signed displacements no larger than 32 bits), direct jump targets of the untrusted application never displace the execution into the security monitor. Trusted code pages with direct jumps that target authorized entry points may be allowed close enough to the security monitor that they can operate.

Some embodiments may mark certain memory regions as unreachable by indirect branches, even without CET being enabled. All indirect branches may be blocked from targeting those regions, or there could be separate controls for different types of indirect branches such as jumps, calls, and returns. For example, the processor may generate an exception in response to an attempt to execute a blocked branch. There could be arbitrary combinations of controls, such as a combined control for jumps and calls and a distinct control for returns. Each configuration of the controls could be associated with one or more memory regions (e.g., pages as indicated by individual page table entry bit settings, pages with specified protection key values, address ranges specified in registers such as Model-Specific Registers (MSRs), etc.). For example, the locations containing the security monitor could be specified using these controls. Alternatively, entire address spaces or operating modes (e.g., as specified by a bit in a control register such as the X86 Control Register 3 (CR3), X86 Control Register 4 (CR4), or an MSR bit), could be set to enforce these restrictions. Non-blocked branch types such as direct branches may still be used to invoke code on marked pages. Certain configurations could maintain protection of the security monitor even with other control-flow integrity enforcement partially or fully disabled. For example, if all indirect branches were blocked from targeting the security monitor, then control-flow integrity enforcement could be fully disabled. Code pages that could potentially reach the security monitor using direct branches may be scanned prior to execution to check that none of those direct branches, even unintended direct branch gadgets, target an unauthorized entry point to the security monitor. If indirect jumps and calls are blocked from targeting the security monitor, but returns are not blocked, then a reverse-edge control flow integrity mechanism (e.g., CET shadow stack), may be enabled to block unauthorized returns.

Some embodiments may block direct branches located outside of the security monitor from targeting any destination location within a security monitor other than an authorized entry point (e.g., as marked by an ENDBRANCH instruction). Direct branches originating within the security monitor, however, may still be permitted to target destination locations both within and outside of the security monitor. The processor may determine whether the branch and separately its targeted destination address are located within the security monitor using a mechanism that specifies the security monitor locations as described in the preceding paragraph. Analogously, separate or combined controls may be defined to block indirect branches located outside of the security monitor from targeting any destination location within a security monitor other than an authorized entry point (e.g., as marked by an ENDBRANCH instruction). These controls may distinguish between different types of indirect branches or control them all similarly. For example, blocking returns that are outside of the security monitor from invoking code in the security monitor may provide a benefit by permitting overhead from a shadow stack to be avoided assuming that return addresses stored on the stack are invulnerable (e.g., due to execution being single-threaded or per-thread memory protection blocking cross-thread return address corruption).

In one example, LibOSes service a subset of system calls in user mode without invoking the kernel. For example, the LibOSes are sometimes used in enclaves to support legacy applications while minimizing the frequency of enclave exits to improve performance and to minimize dependence on untrusted host kernel code.

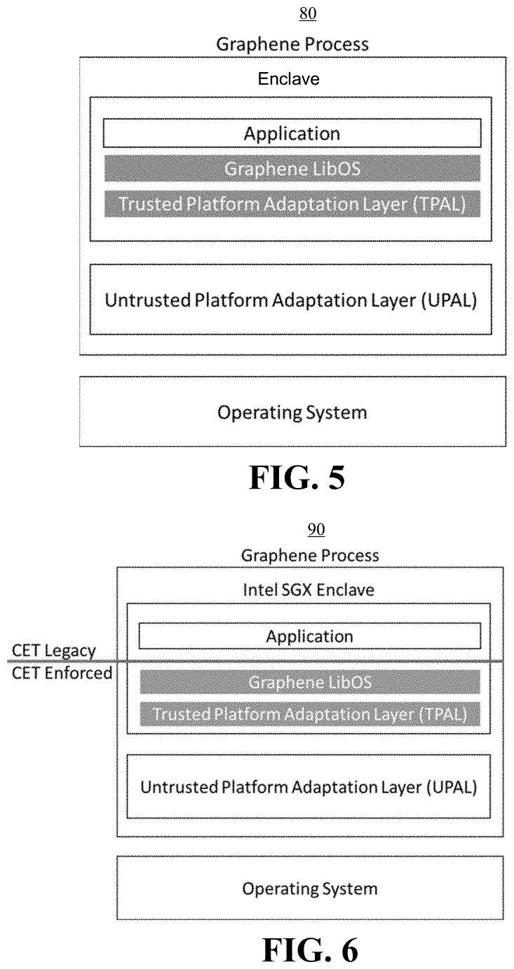

FIG. 5 is an example of a LibOS system configuration 80 based on GRAPHENE in SGX, although many other system configurations are also possible.

An enclave mechanism (e.g., logic instructions, configurable logic, fixed-functionality hardware logic, etc., or any combination thereof) such as, for example, INTEL SGX, may be used to mitigate outside attacks on the application, LibOS, and trusted platform adaptation layer (TPAL) components. In an embodiment, the LibOS implements security relevant checks based on a manifest. For example, the manifest might describe a list of trusted files identified by a cryptographic hash of the content, where the LibOS checks ensure that file accesses comply with the provided list. The application, LibOS and TPAL may share the same memory region, such that the application can invoke any code in the LibOS and TPAL by default. Thus, security vulnerabilities in the application make checks in the LibOS and TPAL potentially vulnerable to circumvention.

There are similar requirements in this case as for the security monitor described previously, in that the LibOS is able to inspect all system calls so that the application is unable to bypass the LibOS and directly invoke the kernel.

FIG. 6 demonstrates that the same mechanism described for the security monitor may also be applied to enforce this restriction, as illustrated in a system configuration 90. In the illustrated example, an untrusted platform adaptation layer (UPAL) prevents “ocalls” from the application. In one example, ocalls are the mechanism by which an enclave can invoke functionality of the host. The UPAL may redirect ocalls to the LibOS, since only the LibOS is authorized to perform the ocalls.

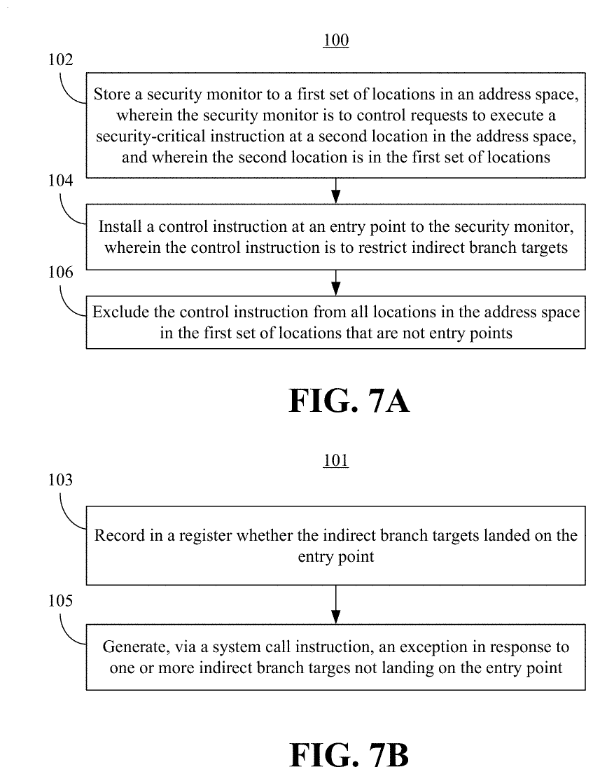

FIG. 7A shows a method 100 of operating a performance-enhanced computing system. The method 100 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 102 provides for storing a security monitor at a first set of locations in an address space (e.g., memory page), wherein the security monitor is to control requests to use a security-critical instruction (e.g., system call) at a second location in the address space contained in the first set of locations. Block 104 installs a control instruction (e.g., ENDBRANCH, BTI) at an entry point to the security monitor, wherein the control instruction is to restrict indirect branch targets. In an embodiment, block 106 excludes the control instruction from all locations within the security monitor that are not authorized entry points. Blocks 102, 104 or 106 may also provide for marking one or more memory regions as unreachable by indirect branches.

FIG. 7B shows a method 101 of operating a performance-enhanced computing system. The method 101 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 101 records in a register whether indirect branch targets land on an entry point. In an embodiment, block 105 generates, via a system call instruction, an exception in response to one or more indirect branch targets not landing on the entry point.

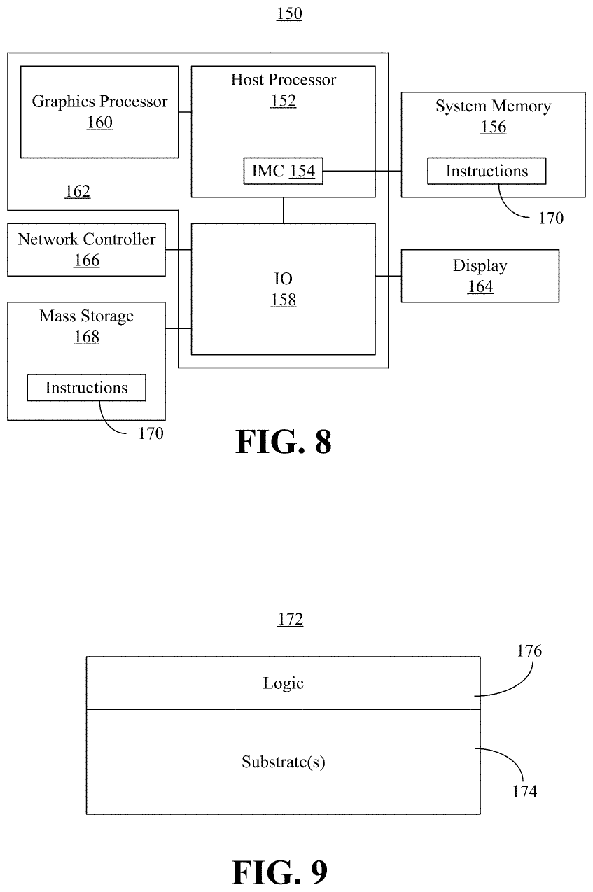

FIG. 8 shows a computing system 150 including executable program instructions 170, which when executed by one or more of a host processor 152, a graphics processor 160 or an input/output module (IO) 158, cause the computing system 150 to perform one or more aspects of the method 30 (FIG. 2), the method 50 (FIG. 3), the method 60 (FIG. 4), and/or the method 100 (FIG. 7), already discussed. The system 150 is considered performance-enhanced at least to the extent that attempts to bypass sandbox security monitors in native code are blocked. In an embodiment, the instructions 170 are retrieved from system memory 156 and/or mass storage 168. Additionally, the graphics processor 160, the host processor 152 and/or the IO module 158 are incorporated into a system on chip (SoC) 162, which is also coupled to a display 164 and/or a network controller 166 (wireless, wired).

FIG. 9 shows a semiconductor package apparatus 172. The illustrated apparatus 172 includes one or more substrates 174 (e.g., silicon, sapphire, gallium arsenide) and logic 176 (e.g., transistor array and other integrated circuit/IC components) coupled to the substrate(s) 174. The logic 176 may be implemented at least partly in configurable logic or fixed-functionality logic hardware. In one example, the logic 176 implements one or more aspects of the method 30 (FIG. 2), the method 50 (FIG. 3), the method 60 (FIG. 4), the method 100 (FIG. 7A) and/or the method 101 (FIG. 7B), already discussed. Thus, the logic 176 may store a security monitor to a first set of locations in an address space, wherein the security monitor is to control requests to execute a security-critical instruction at a second location in the address space, and wherein the second location is in the first set of locations. In an embodiment, the logic 176 also installs a control instruction at an entry point to the security monitor, wherein the control instruction is to restrict indirect branch targets, and exclude the control instruction from all locations in the address space in the first set of locations that are not entry points. Moreover, the logic 176 may mark one or more memory regions as unreachable by indirect branches.

In one example, the logic 176 includes transistor channel regions that are positioned (e.g., embedded) within the substrate(s) 174. Thus, the interface between the logic 176 and the substrate(s) 174 may not be an abrupt junction. The logic 176 may also be considered to include an epitaxial layer that is grown on an initial wafer of the substrate(s) 174.

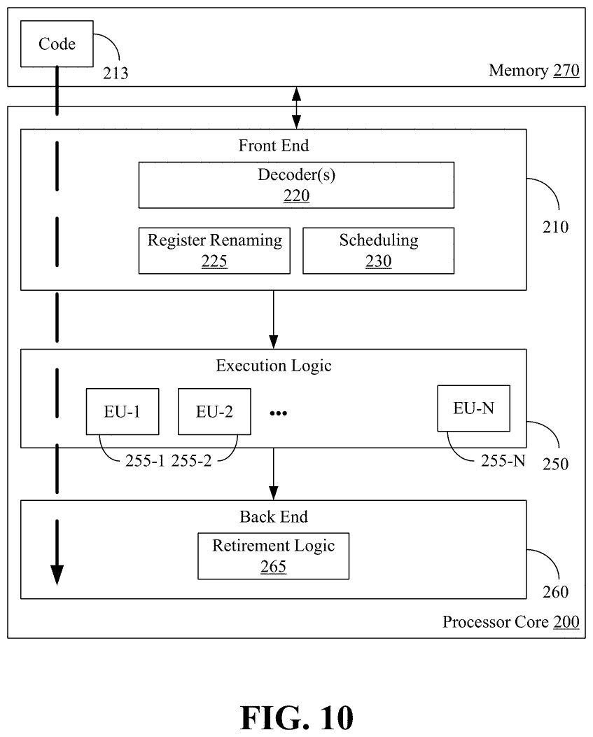

FIG. 10 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 10, a processing element may alternatively include more than one of the processor core 200 illustrated in FIG. 10. The processor core 200 may be a single-threaded core or, for at least one embodiment, the processor core 200 may be multithreaded in that it may include more than one hardware thread context (or “logical processor”) per core.

FIG. 10 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 30 (FIG. 2), the method 50 (FIG. 3), the method 60 (FIG. 4), the method 100 (FIG. 7A) and/or the method 101 (FIG. 7B), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 10, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

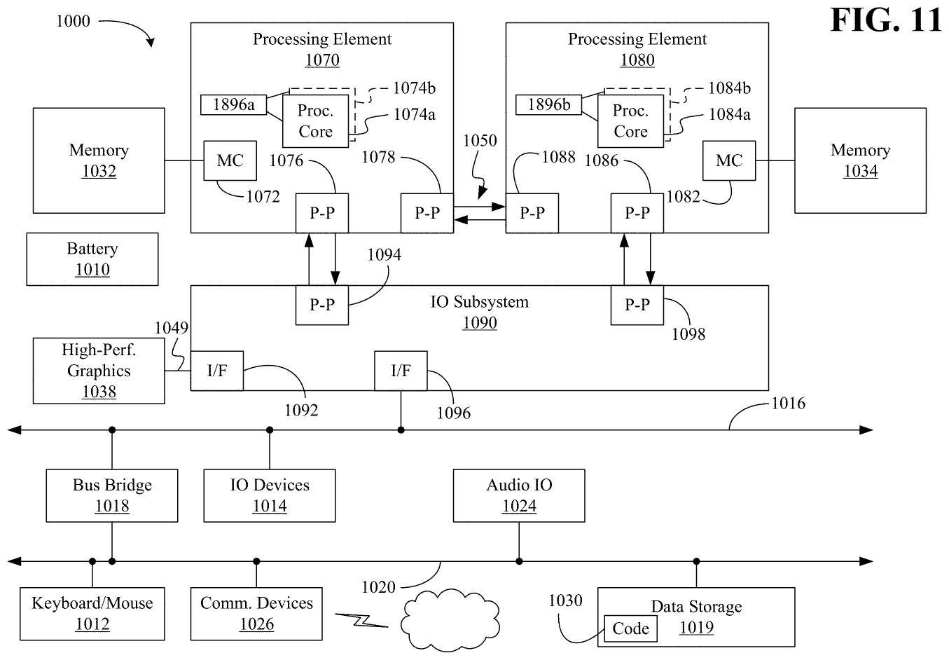

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of the method 30 (FIG. 2), the method 50 (FIG. 3), the method 60 (FIG. 4), the method 100 (FIG. 7A) and/or the method 101 (FIG. 7B), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### ADDITIONAL NOTES AND EXAMPLES

Example 1 includes a performance-enhanced computing system comprising a network controller, a processor coupled to the network controller, and a memory coupled to the processor, the memory including a set of executable program instructions, which when executed by the processor, cause the computing system to store a security monitor to a first set of locations in an address space, wherein the security monitor is to control requests to execute a security-critical instruction at a second location in the address space, and wherein the second location is in the first set of locations, install a control instruction at an entry point to the security monitor, wherein the control instruction is to restrict indirect branch targets, and exclude the control instruction from all locations in the address space in the first set of locations that are not entry points.

Example 2 includes the computing system of Example 1, wherein the set of instructions, when executed, cause the computing system to conduct a scan of executable binary code in an untrusted application for one or more jump instructions, and record a set of jump targets associated with the one or more jump instructions, wherein the security monitor is stored to the first set of locations if at least one of the one or more jump instructions target unauthorized entry points within the security monitor.

Example 3 includes the computing system of Example 2, wherein the set of instructions, when executed, cause the computing system to repeat the scan of the executable binary code if additional binary code is dynamically added.

Example 4 includes the computing system of Example 1, wherein the security-critical instruction is to be a system call.

Example 5 includes the computing system of any one of Examples 1 to 4, wherein the control instruction is to be one of an ENDBRANCH instruction or a Branch Target Identification instruction.

Example 6 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to store a security monitor to a first set of locations in an address space, wherein the security monitor is to control requests to execute a security-critical instruction at a second location in the address space, and wherein the second location is in the first set of locations, install a control instruction at an entry point to the security monitor, wherein the control instruction is to restrict indirect branch targets, and exclude the control instruction from all locations in the address space in the first set of locations that are not entry points.

Example 7 includes the semiconductor apparatus of Example 6, wherein the logic coupled to the one or more substrates is to conduct a scan of executable binary code in an untrusted application for one or more jump instructions, and record a set of jump targets associated with the one or more jump instructions, wherein the security monitor is stored to the first set of locations if at least one of the one or more jump instructions target unauthorized entry points within the security monitor.

Example 8 includes the semiconductor apparatus of Example 7, wherein the logic coupled to the one or more substrates is to repeat the scan of the executable binary code if additional binary code is dynamically added.

Example 9 includes the semiconductor apparatus of Example 6, wherein the security-critical instruction is to be a system call.

Example 10 includes the semiconductor apparatus of Example 6, wherein the control instruction is to be one or more of an ENDBRANCH instruction or a Branch Target Identification instruction.

Example 11 includes the semiconductor apparatus of Example 6, wherein the logic coupled to the one or more substrates is to record in a register whether the indirect branch targets landed on the entry point, and generate, via a system call instruction, an exception in response to one or more indirect branch targets not landing on the entry point.

Example 12 includes the semiconductor apparatus of any one of Examples 6 to 11, wherein the logic coupled to the one or more substrates is to mark one or more memory regions as unreachable by indirect branches.

Example 13 includes at least one computer readable storage medium comprising a set of instructions, which when executed by a computing system, cause the computing system to store a security monitor to a first location in an address space, wherein the security monitor is to control requests to execute a security-critical instruction at a second location in the address space, and wherein the second location is in the first set of locations, install a control instruction at an entry point to the security monitor, wherein the control instruction is to restrict indirect branch targets, and exclude the control instruction from all locations in the address space in the first set of locations that are not entry points.

Example 14 includes the at least one computer readable storage medium of Example 13, wherein the set of instructions, when executed, cause the computing system to conduct a scan of executable binary code in an untrusted application for one or more jump instructions, and record a set of jump targets associated with the one or more jump instructions, wherein the security monitor is stored to the first set of locations if at least one of the one or more jump instructions target unauthorized entry points within the security monitor.

Example 15 includes the at least one computer readable storage medium of Example 14, wherein the set of instructions, when executed, cause the computing system to repeat the scan of the executable binary code if additional binary code is dynamically added.

Example 16 includes the at least one computer readable storage medium of Example 13, wherein the security-critical instruction is to be a system call.

Example 17 includes the at least one computer readable storage medium of Example 13, wherein the control instruction is to be one or more of an ENDBRANCH instruction or a Branch Target Identification instruction.

Example 18 includes the at least one computer readable storage medium of Example 13, wherein the set of instructions, when executed, cause the computing to record in a register whether the indirect branch targets landed on the entry point, and generate, via a system call instruction, an exception in response to one or more indirect branch targets not landing on the entry point.

Example 19 includes the at least one computer readable storage medium of any one of Examples 13 to 18, wherein the set of instructions, when executed, cause the computing system to mark one or more memory regions as unreachable by indirect branches.

Example 20 includes a method of operating a performance-enhanced computing system, the method comprising storing a security monitor to a first location in an address space, wherein the security monitor is to control requests to execute a security-critical instruction at a second location in the address space, and wherein the second location is in the first set of locations, installing a control instruction at an entry point to the security monitor, wherein the control instruction is to restrict indirect branch targets, and excluding the control instruction from all locations in the address space in the first set of locations that are not entry points.

Example 21 includes the method of Example 20, further including conducting a scan of executable binary code in an untrusted application for one or more jump instructions, and recording a set of jump targets associated with the one or more jump instructions, wherein the security monitor is stored to the first set of locations if at least one of the one or more jump instructions target unauthorized entry points within the security monitor.

Example 22 includes the method of Example 21, further including repeating the scan of the executable binary code if additional binary code is dynamically added.

Example 23 includes the method of Example 20, wherein the security-critical instruction is a system call.

Example 24 includes the method of any one of Examples 20 to 23, wherein the control instruction is one or more of an ENDBRANCH instruction or a Branch Target Identification instruction.

The use of the technology described herein may be implemented at program runtime via a CET legacy code page bitmap that is configured to require ENDBRANCH instructions on only a small number of pages used to enforce sandboxing security policies. Additionally, sandboxing native code need not be fully instrumented with ENDBRANCH instructions on OS kernels that are unaware of user mode compartments.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of executable program instructions, which when executed by the processor, cause the computing system to:
store a security monitor to a first set of locations in an address space, wherein the security monitor is to control requests to execute a security-critical instruction at a second location in the address space, and wherein the second location is in the first set of locations,
install a control instruction at an entry point to the security monitor, wherein the control instruction is to restrict indirect branch targets, and
exclude the control instruction from all locations in the address space in the first set of locations that are not entry points.

2. The computing system of claim 1, wherein the set of instructions, when executed, cause the computing system to:
conduct a scan of executable binary code in an untrusted application for one or more jump instructions, and
record a set of jump targets associated with the one or more jump instructions, wherein the security monitor is stored to the first set of locations if at least one of the one or more jump instructions target unauthorized entry points within the security monitor.

3. The computing system of claim 2, wherein the set of instructions, when executed, cause the computing system to repeat the scan of the executable binary code if additional binary code is dynamically added.

4. The computing system of claim 1, wherein the security-critical instruction is to be a system call.

5. The computing system of claim 1, wherein the control instruction is to be one of an ENDBRANCH instruction or a Branch Target Identification instruction.

6. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
store a security monitor to a first set of locations in an address space, wherein the security monitor is to control requests to execute a security-critical instruction at a second location in the address space, and wherein the second location is in the first set of locations;
install a control instruction at an entry point to the security monitor, wherein the control instruction is to restrict indirect branch targets; and
exclude the control instruction from all locations in the address space in the first set of locations that are not entry points.

7. The semiconductor apparatus of claim 6, wherein the logic coupled to the one or more substrates is to:
conduct a scan of executable binary code in an untrusted application for one or more jump instructions; and
record a set of jump targets associated with the one or more jump instructions, wherein the security monitor is stored to the first set of locations if at least one of the one or more jump instructions target unauthorized entry points within the security monitor.

8. The semiconductor apparatus of claim 7, wherein the logic coupled to the one or more substrates is to repeat the scan of the executable binary code if additional binary code is dynamically added.

9. The semiconductor apparatus of claim 6, wherein the security-critical instruction is to be a system call.

10. The semiconductor apparatus of claim 6, wherein the control instruction is to be one or more of an ENDBRANCH instruction or a Branch Target Identification instruction.

11. The semiconductor apparatus of claim 6, wherein the logic coupled to the one or more substrates is to:
record in a register whether the indirect branch targets landed on the entry point; and
generate, via a system call instruction, an exception in response to one or more indirect branch targets not landing on the entry point.

12. The semiconductor apparatus of claim 6, wherein the logic coupled to the one or more substrates is to mark one or more memory regions as unreachable by indirect branches.

13. At least one computer readable storage medium comprising a set of instructions, which when executed by a computing system, cause the computing system to:
store a security monitor to a first location in an address space, wherein the security monitor is to control requests to execute a security-critical instruction at a second location in the address space, and wherein the second location is in the first set of locations;
install a control instruction at an entry point to the security monitor, wherein the control instruction is to restrict indirect branch targets; and
exclude the control instruction from all locations in the address space in the first set of locations that are not entry points.

14. The at least one computer readable storage medium of claim 13, wherein the set of instructions, when executed, cause the computing system to:
conduct a scan of executable binary code in an untrusted application for one or more jump instructions; and
record a set of jump targets associated with the one or more jump instructions, wherein the security monitor is stored to the first set of locations if at least one of the one or more jump instructions target unauthorized entry points within the security monitor.

15. The at least one computer readable storage medium of claim 14, wherein the set of instructions, when executed, cause the computing system to repeat the scan of the executable binary code if additional binary code is dynamically added.

16. The at least one computer readable storage medium of claim 13, wherein the security-critical instruction is to be a system call.

17. The at least one computer readable storage medium of claim 13, wherein the control instruction is to be one or more of an ENDBRANCH instruction or a Branch Target Identification instruction.

18. The at least one computer readable storage medium of claim 13, wherein the set of instructions, when executed, cause the computing to:
record in a register whether the indirect branch targets landed on the entry point; and
generate, via a system call instruction, an exception in response to one or more indirect branch targets not landing on the entry point.

19. The at least one computer readable storage medium of claim 13, wherein the set of instructions, when executed, cause the computing system to mark one or more memory regions as unreachable by indirect branches.

20. A method comprising:
storing a security monitor to a first location in an address space, wherein the security monitor is to control requests to execute a security-critical instruction at a second location in the address space, and wherein the second location is in the first set of locations;
installing a control instruction at an entry point to the security monitor, wherein the control instruction is to restrict indirect branch targets; and
excluding the control instruction from all locations in the address space in the first set of locations that are not entry points.

21. The method of claim 20, further including:
conducting a scan of executable binary code in an untrusted application for one or more jump instructions; and
recording a set of jump targets associated with the one or more jump instructions, wherein the security monitor is stored to the first set of locations if at least one of the one or more jump instructions target unauthorized entry points within the security monitor.

22. The method of claim 21, further including repeating the scan of the executable binary code if additional binary code is dynamically added.

23. The method of claim 20, wherein the security-critical instruction is a system call.

24. The method of claim 20, wherein the control instruction is one or more of an ENDBRANCH instruction or a Branch Target Identification instruction.
